(19) United States
(12) Patent Application Publication
(10) Pub. No.: US 2013/0050371 A1
(43) Pub. Date: Feb. 28, 2013

(54) PERSONALIZED COVER FOR ELECTRONIC DEVICES AND METHOD OF PRODUCING SAME

(71) Applicant: Paul Hirst, Sheffield (GB)

(72) Inventor: Paul Hirst, Sheffield (GB)

(73) Assignee: MARVELPRESS, LLC, Salt Lake City, UT (US)

(21) Appl. No.: 13/216,524

(22) Filed: Aug. 24, 2011

(51) Int. Cl. B41J 2/01

(52) U.S. Cl. 347/103

(57) ABSTRACT

A customized cover for a handheld electronic device. A back of the cover is opposite the first side, and substantially covers the back of the handheld electronic device. The backside or second side of the cover is flat along substantially its entire length, and the cover is substantially white for receiving and displaying a color image that is customized for the user of the handheld electronic device. The cover may comprise a polymer that permits permanent imaging by infusion of specialty inks to the polymer. A digital image is printed on an intermediate transfer substrate. The image is transferred under heat and pressure to the back or second side of the cover, so that the customized image appears on the cover. The invention may employ tools to secure the case during the printing process, and additional tools during a post-imprinting cooling and image stabilization phase, to prevent heat distortion of the cover during imaging.

### FIELD OF THE INVENTION

This invention relates to digital and transfer printing methods, and to a cover for handheld electronic devices produced by such methods.

### BACKGROUND OF THE INVENTION

Handheld electronic devices are in widespread and ever increasing use. Small, thin and lightweight cellular telephones, digital music players, computers and communication devices are sized to easily fit within the palm of an average user's hand. They are generally rectangular in footprint, and may be characterized by a back surface, a front screen and/or keyboard, and four (4) sides that form a rectangular perimeter between the front and the back.

Many consumers use such handheld electronic devices with aftermarket or auxilliary protective or decorative covers. These covers substantially cover the back and sides, and have a front opening for access to screen, keyboard and/or controls.

These covers may be mass-produced in vibrant colors, or with designs or images. However, many users prefer to personalize their covers so that the mass-produced handheld electronic device is unique to the user.

Personalization may be performed by transfer printing processes. However, such transfer printing processes are not easily adapted to covers that are in widespread use, since the covers have rounded surfaces that do not permit two-dimensional images to be placed thereon without the curved surface skewing or distorting the image. Further, the covers tend to be plastic, and are not always suitable for heat initiated transfer imaging that can distort the plastic cover and/or the image. Still further, the covers in widespread use tend to be of darker opaque colors, and do not lend themselves to full color transfer imaging. There is a need for a device and process that will permit rapid, precise and inexpensive personalization of covers for handheld electronic devices.

### SUMMARY OF THE INVENTION

The present invention is a customized cover for a handheld electronic device. The cover is characterized by a hollow or open interior, with a first side of the cover open to in which the handheld electronic device is held securely, and which permits open access to the screen or similar display and/or keyboard or similar controls of the device. A second side, or back, of the cover is opposite the first side, and substantially covers the back of the handheld electronic device. The backside or second side of the cover is flat along substantially its entire length, and the cover is substantially white for receiving and displaying a color image that is customized for the user of the handheld electronic device. The cover may comprise a polymer that permits permanent imaging by infusion of specialty inks to the polymer.

A digital image is prepared, and is printed on an intermediate transfer substrate. The resulting printed image is comprised of heat-transferable colorant. The image is transferred under heat and pressure to the back or second side of the cover, so that the customized image appears on the cover.

Transfer of the personalization image requires heat and pressure that normally will distort the case. The invention may employ tools to secure the case during the printing process, and additional tools during a post-imprinting cooling and image stabilization phase.

### BRIEF DESCRIPTION OF THE DRAWINGS

FIG. 1 is a perspective view of a cover for a handheld electronic device according to the invention.

FIG. 2 demonstrates a digital image prepared by a computing device, with the digital image printed on an intermediate transfer substrate by a digital printer that communicates with the computing device.

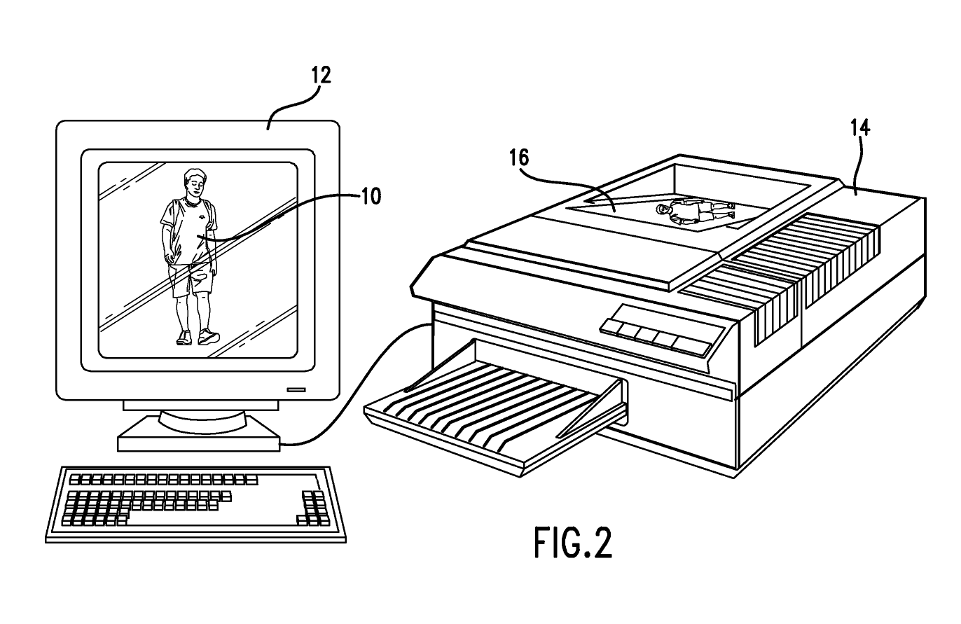

FIG. 3 is an exploded view of the intermediate transfer substrate, the cover, and a jig that maintains structural integrity of the cover during heat transfer.

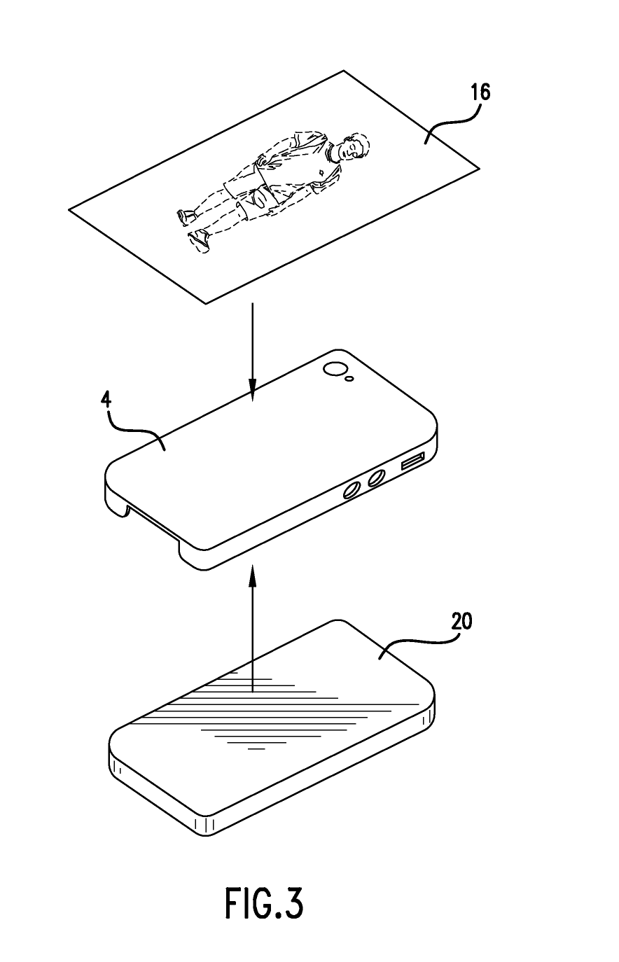

FIG. 4 demonstrates heat transfer of the printed image from the intermediate transfer substrate to the back or second side of the cover.

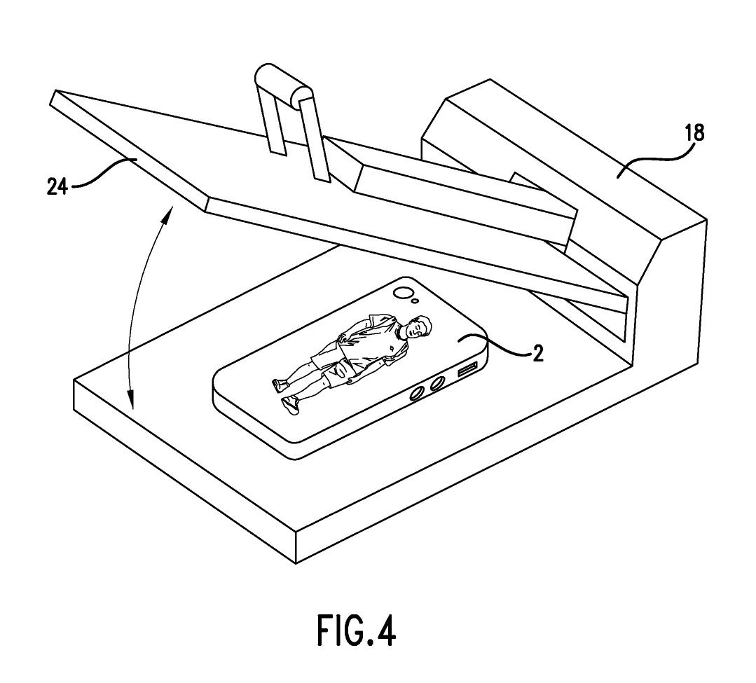

FIG. 5 demonstrates a cooling jig into which heated imaged covers are inserted for cooling and shape stabilization.

FIG. 6 shows a top, plan view of a cover for a handheld electronic device imaged according to the process described herein.

### DESCRIPTION OF PREFERRED EMBODIMENTS

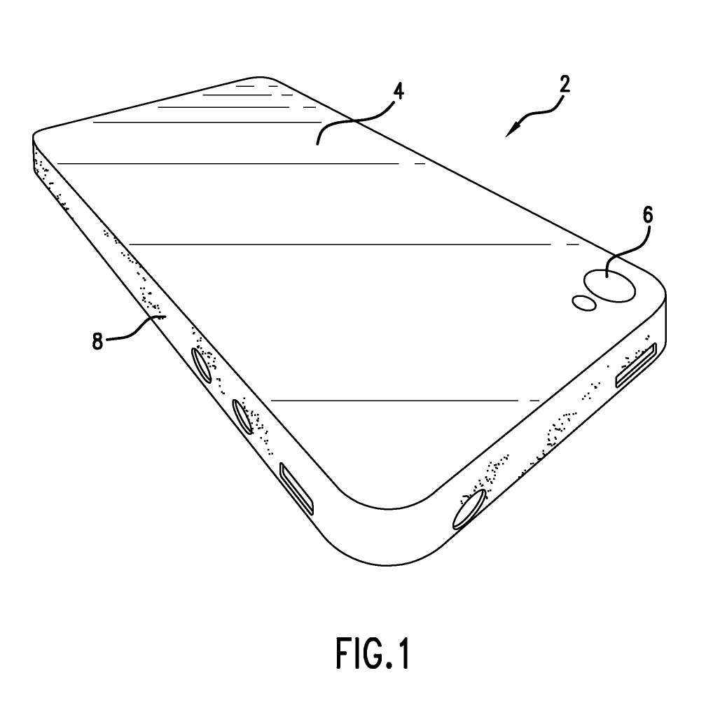

FIG. 1 shows a cover 2 for a handheld electronic device that is suitable for producing a customized cover for a handheld electronic device according to the invention. The cover is constructed to accept and hold a particular handheld electronic device.

FIG. 1 shows the back 4, or second side, of the cover prior to imaging and customization. In this embodiment, the entire second side is flat. The flat surface is in a single plane, producing a two-dimensional surface for printing and customization. The flat surface may have openings 6 for access to controls or insertion of cords or the like, but the surface of the back or second side as shown is in a single plane and does not have peaks or valleys or undulations or other surface characteristics that would create a three-dimensional surface.

Adjoining the back or second side are four (4) sides 8 which form a perimeter around the back or second side. As can be seen from FIG. 1, the flat surface of the back or second side is consistently in a single plane as it joins the vertical sides, resulting in a defined edge that is between the sides and the back or second side. Curved surfaces are not present in this embodiment where the back joins the generally vertical sides.

The interior of the cover is generally hollow for receiving the handheld electronic device. The front or first side of the cover which is opposite the backside is spaced apart from the back or second side by the generally vertically sides. A material portion of the front or first side is open for access to the generally hollow interior of the cover so that the handheld electronic device can be inserted into the cover. This structure also permits a screen and/or keyboard of the handheld electronic device to be used through the opening.

The flat surface of the back or second side is substantially white. “Substantially white” means a surface that is white, or has slight coloration that will not materially interfere with a color image, which may be a full color image, printed on the back or second side. The substantially white surface may have a slight coloration of, for example, beige, blue, green, gray or pink, but such coloration is preferred to not materially obscure or modify the color presentation of the image produced by the heat-transferable or heat-activated colorants that are used to produce the printed image on the cover.

To form the image on the cover for customization of the cover, a digital image 10 is captured that is capable of being printed. The image may be a digital photograph or an image that is digitally created. Many software packages, such as those produced by Adobe and others, may be used to create and capture digital images according to the skills of the producer of the image. A computer 12 may be used to produce the image.

Once the image is created, a digital printer 14 prints the image on a two-dimensional intermediate transfer substrate 16 which, according to one embodiment, is paper. In a preferred embodiment, the image is formed with inks or toners that comprise sublimation dyes. The printed image may be formed with the type of printer selected according to the ink or toner, such as an inkjet printer or a laser printer. Heat-activated/heat-transferable colorants, such as sublimation dyes, form the printed image by use of the printer. For example, the printer may be an inkjet printer that prints SubliJet® inkjet inks or ArTainium® inkjet inks.

The cover is prepared for printing. A process jig may be inserted into the interior of the cover through the open or front side of the cover. The jig is preferred to occupy substantially the same space as the portable electronic device, with substantially no unoccupied space inside the cover. This structure retards uneven application of pressure during the imaging process to help avoid undesirable distortion and/or shrinkage of the cover. The jig may be formed as a block of material comprising metal, such as aluminum, or composite, ceramic or engineering plastic/polymer that is constructed to sufficient tolerances to fit within the cover as required. Insertion of the jig into the cover prevents deformation of the plastic, composite, or polymeric cover upon the application of heat and pressure to the cover to transfer the printed image. The jig maintains the shape of the cover when heated, and importantly, maintains the back or second side as a two-dimensional surface for receiving the printed image from the two-dimensional surface of the intermediate transfer substrate, so that there is no skewing, smearing or deformation of the image. Also, the jig prevents the plastic cover from collapsing or being misformed as heat and pressure are applied to the cover. To obtain optimal outcomes of the imaged covers, the thermal behavior or physical property of the jig material, including heat capacity, shrinkage rate and thermal distortion temperature (HDT) should be substantially stable and consistent, so that the jig itself does not expand, distort or shrink substantially during and/or after the heat transfer process.

In a preferred embodiment, the image is printed on an intermediate transfer substrate that is only slightly larger than the footprint of the back or second side of the cover. The intermediate transfer substrate is preferred to be of sufficient size that the substrate will provide a border around the image, but the border is preferred to be 2.5 cm or less on all four (4) sides of the image. The image is preferred to be sized and shaped to be no larger than very slightly larger than the back or second side of the cover, so that the image extends just slightly beyond each side and each corner of the back or second side of the cover. Preferred intermediate substrates may be those suitable for various imaging processes, such as digital inkjet, electrophotographic image forming, or thermal transfer printing. Physical forms of the substrate may be coated or non-coated paper, plastic or metalized film or tape, fabric sheet with or without back support. Releasing coating may also be applied to the intermediate substrate to prevent withholding printed image during the image transfer process.

The intermediate transfer substrate with the printed image present thereon is placed against the back or second side of the cover. The image is aligned so that the image is positioned against, and registers with, the back or second side of the cover. By using an intermediate receiving substrate that is not materially larger than the back or second side of the cover, registration can be readily and properly accomplished. The image should not be positioned in contact with the sides of the cover.

The imaged intermediate transfer substrate is preferred to be attached to the cover after the substrate is properly aligned with the cover. Attachment may be accomplished by attaching a piece of tape at each end of the cover that connects the cover to the substrate. The tape is preferred to be heat-resistant to withstand the transfer temperatures of the transfer process.

The intermediate transfer substrate and cover are then placed in a platen-type, or flatbed, heat press 18. This type of heat press has a flat, heated plate 24 that makes contact with the imaged intermediate transfer substrate. The flat plate provides a two dimensional contact surface that contacts the flat and two dimensional back 4 of the cover. Sufficient heat and intimate physical contact from the heat press surface by pressure are applied to the back of the intermediate transfer substrate causing the colorants of the printed image to transfer from the intermediate transfer substrate to the cover. In the case of inks or toners comprising sublimation dyes, pressure is applied at about 150°-240° C. for a sufficient time, ranging from 30 seconds to 10 minutes, to transfer a satisfactory image to the cover. The press may apply pressure at 10-60 psi, which may be applied manually or through the use of pneumatic or hydraulic devices. Without the use of the jig, it would not be possible to apply adequate pressure to the cover to produce an undistorted image.

In order to enhance the image quality, one or more coatings coating may be applied to the surface of the cover of the electronic device after imaging. The coatings may be polyester, polyurethane, acrylic, or epoxides, with various combinations and with various additives to enhanced the receptiveness of the color image, as well as the durability of the performance. Multiple layers of coating may be used depending upon the specific transfer technique that is employed. These coatings typically range from several microns to one millimeter in thickness, and can be cured using moisture polymerization, radiation initiated polymerization, or catalyzed polymerization.

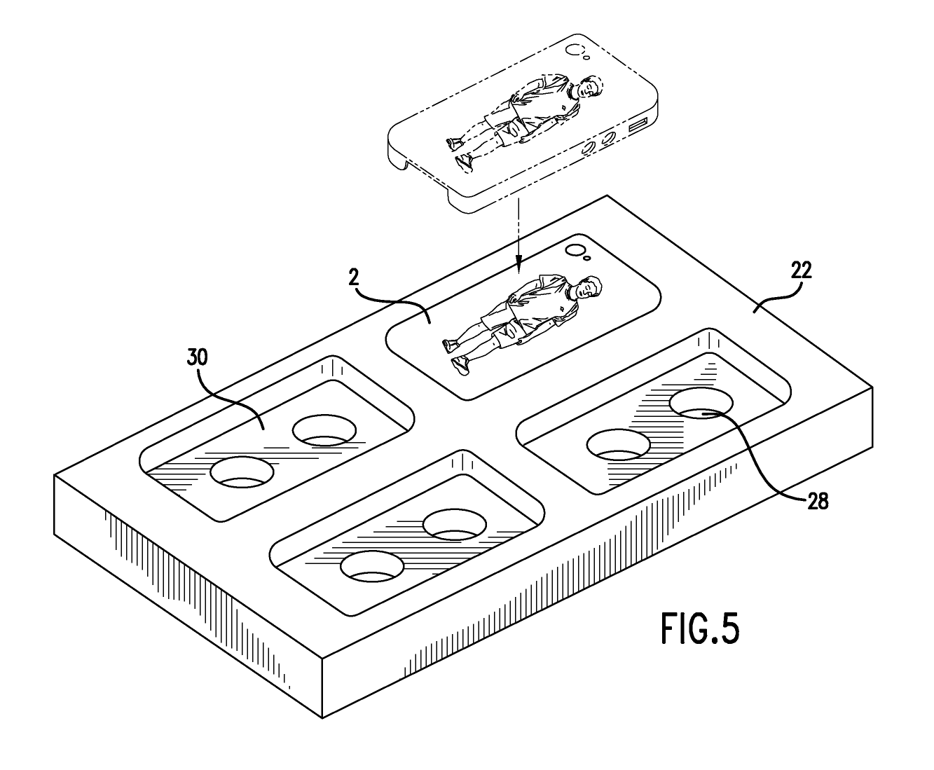

After transfer, the cover is removed from the heat press, and the intermediate transfer substrate is removed, such as by removing the tape from the cover. The cover is preferred to be immediately transferred to a cooling system 22, with the internal jig remaining in the cover, which allows temperature reduction in a controlled manner, and discouraging quick temperature changes that may contribute to shrinkage of the plastic/polymer, and especially dimensionally uneven changes in the cover. FIG. 5. The required shape of the case is maintained, while preventing further “gassing” or dye migration of sublimation dyes into surrounding plastic. After reaching the ambient temperature, the cover is removed from the jig and the cooling system. The cooling system may have a plurality of receiving compartments 30 therein for receiving the heated and imaged covers. The receiving compartments have perimeter that is slightly larger than the perimeter of the covers, which helps to maintain the dimensions of the heated covers. The cooling system may have apertures or conduits 28 therein that contribute to cooling. The cooling system may be cooled by circulating air, compressed air, a refrigerating device, liquids (such as oil or water), or decompressing mechanisms.

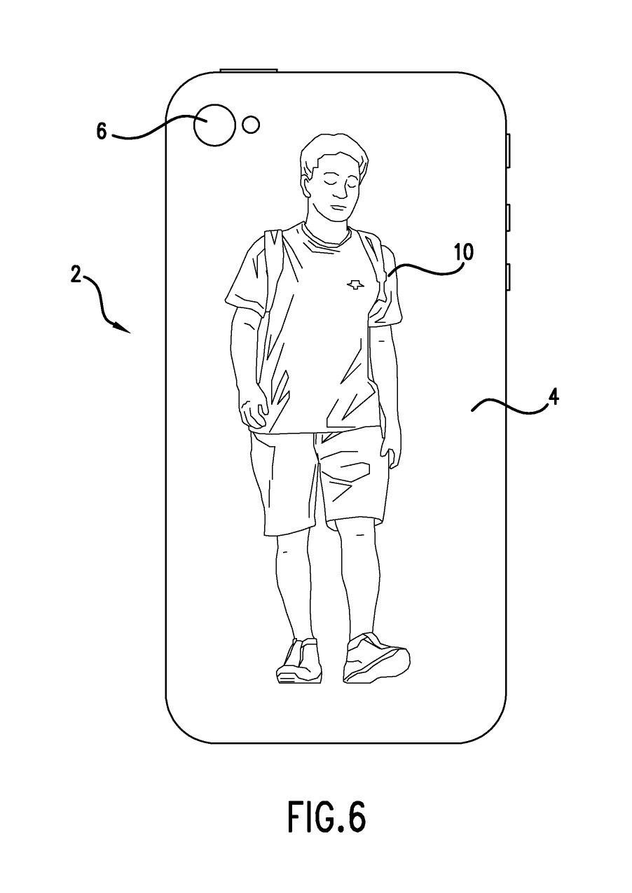

The cover is now imaged with the printed image, yielding an image for a handheld device that is customized with the user's desired image. The customized cover is ready to receive and hold the handheld electronic device. FIG. 6.

What is claimed is:

1. A method of printing a customized cover for a handheld electronic device, comprising the steps of:
preparing a digital image;
printing the image on an intermediate transfer substrate to form a printed image, wherein the printed image comprises heat transferable colorants;
positioning a jig inside a cover for a handheld electronic device, wherein the jig occupies an open interior of the cover and the jig is constructed and arranged to maintain the shape of the cover under heat and pressure, and wherein the cover is characterized by a generally open first side, and substantially white second side that is generally closed and is opposite the first side, wherein the outer surface of the second side is flat, and wherein the first side and the second side are joined by four connecting sides that define the open interior of the cover;
attaching the intermediate transfer substrate to the cover with the printed image in contact with the flat surfaced and substantially white second side;
applying heat and pressure to the intermediate transfer substrate and effecting transfer of the heat transferable colorants of the printed image to the second side; and
removing the jig and the intermediate transfer substrate from the cover.

2. A method of printing a customized cover for a handheld electronic device image according to claim 1, wherein the jig occupies substantially an entire interior of the cover.

3. A method of printing a customized cover for a handheld electronic device image according to claim 1, wherein the jig comprises thermal conductivity properties, and the jig is in contact with the cover during and after transfer of the printed image to the cover and the jig conducts heat from the cover.

4. A method of printing a customized cover for a handheld electronic device image according to claim 1, wherein the jig comprises metal and the jig comprises thermal conductivity properties, and the jig is in contact with the cover during and after transfer of the printed image to the cover and the jig conducts heat from the cover.

5. A method of printing a customized cover for a handheld electronic device image according to claim 1, further comprising the step of placing the cover in a cooling system comprising a receiving compartment after effecting transfer of the printed image and before removal of the jig from the cover.

6. A method of printing a customized cover for a handheld electronic device image according to claim 1, further comprising the step of placing the cover in a cooling system comprising a receiving compartment after effecting transfer of the printed image and before removal of the jig from the cover, wherein the receiving compartment comprises a conduit for transmission of cooling gas or liquid.

7. A method of printing a customized cover for a handheld electronic device image according to claim 1, wherein the heat transferable colorants comprise sublimation dye.

8. A method of printing a customized cover for a handheld electronic device image according to claim 1, wherein the intermediate transfer substrate is substantially the same size as the image.

9. A method of printing a customized cover for a handheld electronic device image according to claim 1, wherein heat and pressure is applied to the intermediate transfer substrate using a heat press that comprises a heated and flat platen that contacts the intermediate transfer substrate.

10. A method of printing a customized cover for a handheld electronic device image according to claim 1, wherein the image that is present on the intermediate transfer substrate is not materially larger than the second side of the cover.

11. A method of printing a customized cover for a handheld electronic device image according to claim 1, further comprising the step of coating the image with a protective coating after effecting transfer of the printed image.
